(19) United States
(12) Patent Application Publication
(10) Pub. No.: US 2023/0291071 A1
(43) Pub. Date: Sep. 14, 2023

(54) BATTERY PACK

(71) Applicant: SK ON CO., LTD., Seoul (KR)

(72) Inventors: Ji Hoon LIM, Gyeonggi-do (KR); Seung Hun LEE, Daejeon (KR); Tae Gu LEE, Daejeon (KR); Yang Kyu CHOI, Daejeon (KR)

(21) Appl. No.: 18/180,850

(22) Filed: Mar. 9, 2023

(30) Foreign Application Priority Data
Mar. 14, 2022 (KR) 10-2022-0031635

(51) Int. Cl. H01M 50/383; H01M 50/204; H01M 50/35; H01M 50/48

(52) U.S. Cl. CPC H01M 50/383; H01M 50/204; H01M 50/35; H01M 50/48

(57) ABSTRACT

A battery pack may include a pack housing including an accommodation space and a venting passage connecting the accommodation space to outside, a partition wall member partitioning the accommodation space, a plurality of pack units including battery cells, the plurality of pack units disposed in the accommodation space, and a blocking unit provided between the accommodation space and the venting passage, the blocking unit blocking a substance generated in the pack unit from entering the venting passage.

### CROSS-REFERENCE TO RELATED APPLICATION(S)

This application claims benefit of priority to Korean Patent Application No. 10-2022-0031635 filed on Mar. 14, 2022 in the Korean Intellectual Property Office, the disclosure of which is incorporated herein by reference in its entirety.

### BACKGROUND

### 1. Field

The present disclosure relates to a battery pack.

### 2. Description of Related Art

A secondary battery is a battery capable of being charged and discharged, and an application range thereof is vast, ranging from relatively small portable electronic devices to mid-to-large-sized automobiles and power storage devices.

The secondary battery may be used in the form of a secondary battery cell, and the secondary battery cell may have a form in which a stack having an anode, a cathode, and a separator is disposed within an exterior material and electrolyte is filled.

When a plurality of secondary battery cells are electrically connected to form a battery pack, the battery may have increased capacitance and output. However, the plurality of secondary battery cells present in the battery pack may be exposed to various events, such as being overcharged, exposed to heat, subjected to external shocks, and the like.

Due to such events, a frame may be generated in the battery pack, and internal materials of the secondary battery cell, such as electrodes, may be decomposed. The decomposed materials may be discharged to the outside of the battery pack in the form of high-temperature dust, together with flames.

Such flames not only may cause damage to the battery pack, but also may cause secondary fire in mechanical elements in which the battery is embedded, such as a vehicle.

Related Art 1: KR 10-2020-0029871 A (Mar. 19, 2020)

### SUMMARY

An aspect of the present disclosure is to prevent or minimize thermal runaway and ignition of a battery pack and to improve the safety of the battery pack.

Another aspect of the present disclosure is to prevent or minimize the propagation of flames and ignition, and to prevent or minimize the discharge of a flammable material and a flame to the outside of a battery pack.

According to an aspect of the present disclosure, there is provided a battery pack comprising a pack housing including an accommodation space and a venting passage connecting the accommodation space externally, a partition wall member partitioning the accommodation space, a plurality of pack units including battery cells, the plurality of pack units disposed in the accommodation space, and a blocking unit provided between the accommodation space and the venting passage, the blocking unit blocking a substance generated in the pack unit from entering the venting passage.

The blocking unit may include a first blocking member facing the pack unit and the venting passage, the first blocking member blocking the substance from entering the venting passage while receiving pressure lower than a reference pressure, and a second blocking member disposed within the first blocking member, the second blocking member having a mesh structure.

The first blocking member may be provided to be broken at a pressure higher than or equal to the reference pressure. The second blocking member may be provided to block the substance from entering the venting passage at a pressure higher than or equal to the reference pressure.

The pack unit may include an accommodation frame accommodating at least one of the battery cells, a busbar member provided in the accommodation frame, the busbar member electrically connected to an electrode tab of the battery cell, and at least one cell venting hole provided in the accommodation frame.

The pack housing may have a pack venting hole facing the cell venting hole, the pack venting hole connected to the venting passage. The first blocking member and the second blocking member may be disposed in the pack venting hole.

The blocking unit may include a plurality of first blocking members facing the cell venting hole and the venting passage. The second blocking member may be disposed between the plurality of first blocking members.

The plurality of first blocking members may be formed of a material including an insulating material.

The second blocking member may have a mesh structure having 24 or more eyes per area of 1 in².

The reference pressure may have a value within a range from 1.5 bars to 2.5 bars.

The battery pack may further include a pack cover covering the pack unit.

According to the present disclosure, thermal runaway and ignition of a battery pack may be prevented or minimized.

In addition, according to the present disclosure, the safety of the battery pack may be improved.

In addition, according to the present disclosure, the propagation of a flame and ignition may be prevented or minimized.

In addition, according to the present disclosure, the discharge of a flammable material and a flame to the outside of the battery pack may be prevented or minimized.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a partially exploded perspective view of a battery pack according to an example embodiment of the present disclosure;

FIG. 2 is an exploded perspective view of a battery pack according to an example embodiment of the present disclosure;

FIG. 3 illustrates line I-I′ of FIG. 2;

FIG. 4 illustrates line I-I′ of FIG. 2 according to another example embodiment of the present disclosure;

FIG. 5 is a partial perspective view of a second blocking member according to an example embodiment of the present disclosure; and

FIG. 6 is an exploded perspective view of a battery pack according to another example embodiment of the present disclosure.

### DETAILED DESCRIPTION

In order to assist in an understanding of descriptions of example embodiments of the present disclosure, elements indicated by the same reference numerals in the accompanying drawings are the same elements, and related elements among elements performing the same operation in each example embodiment are indicated by numbers on the same or extended lines.

In addition, in order to clarify the gist of the present disclosure, descriptions of elements and techniques well known in the related art will be omitted. Hereinafter, the present disclosure will be described in detail with reference to the accompanying drawings.

However, the present disclosure is not limited to the presented example embodiments, and may be proposed in other forms in which specific components are added, changed, or deleted by those skilled in the art, but it should be noted that example embodiments proposed in other forms are also included within the idea and the technical scope of the present disclosure.

In the accompanying drawings, an X-axis is a width direction of a battery cell, a Y-axis is a thickness direction of the battery cell, and a Z-axis is a height direction of the battery cell. However, the above-described axes are directions that are arbitrarily set for ease of description.

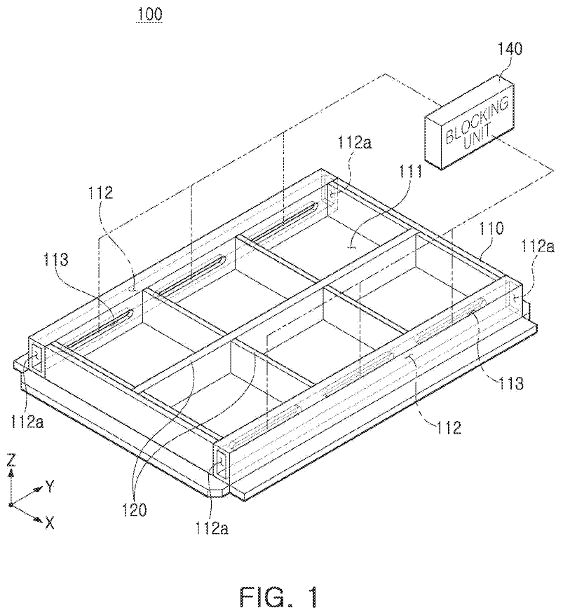

FIG. 1 is a partially exploded perspective view of a battery pack 100 according to an example embodiment of the present disclosure.

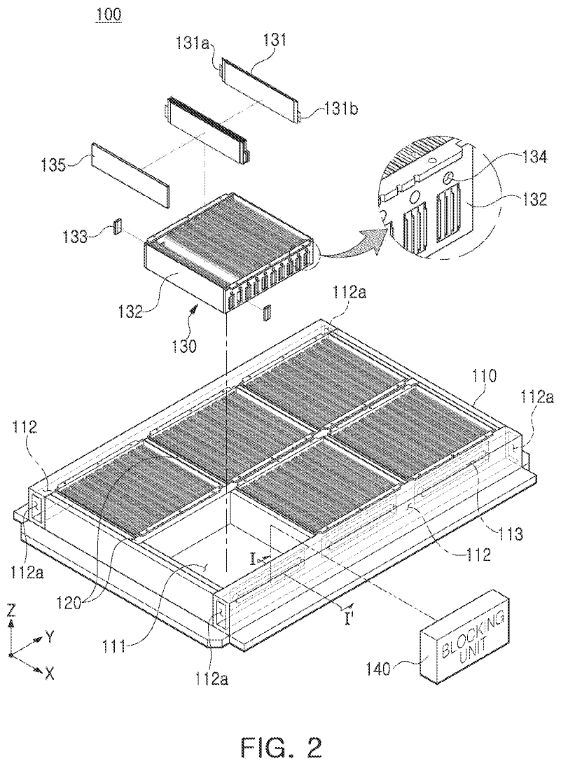

As illustrated in FIG. 1, in an example embodiment of the present disclosure, the battery pack 100 may include a pack housing 110 having an accommodation space 111, and a plurality of pack units (130 in FIG. 2) accommodated in the accommodation space 111. The pack unit (130 in FIG. 2) may include a plurality of battery cells (131 in FIG. 2).

A partition wall member 120, dividing the accommodation space 111 into a plurality of spaces, may be disposed in the pack housing 110. In an example embodiment of the present disclosure, the accommodation space 111 may be partitioned into six accommodation spaces 111 by the partition wall member 120, and the six accommodation spaces 111 may be isolated from each other. Six pack units (130 in FIG. 2) may be accommodated in the six accommodation spaces 111, respectively. However, such configuration corresponds to an example embodiment of the present disclosure, and the number of divided spaces of the accommodation space 111 and the number of pack units (130 in FIG. 2) accommodated in the accommodation space 111 are appropriately selected and applied according to specifications of the battery pack.

The pack housing 110 may include a plurality of venting passages 112. The venting passage 112, a passage provided within the pack housing 110, may be formed by at least a portion of the pack housing 110 being in the form of a hollow.

The venting passage 112 may be connected to the outside of the pack housing 110. An end portion 112a of the venting passage 112 may be in the form of being open, such that the venting passage 112 may be connected to the outside of the pack housing 110. In another example embodiment, the end portion 112a of the venting passage 112 may be blocked by a pressure valve. When internal pressure of the venting passage 112 rises, the pressure valve may open, thereby allowing the venting passage 112 to be connected to the outside of the pack housing 110.

The pack housing 110 may have a pack venting hole 113 opposing the accommodation space 111 in which the pack unit (130 in FIG. 2) is accommodated. A plurality of pack venting holes 113 may be provided. In an example embodiment of the present disclosure, six pack venting holes 113 may oppose the six accommodation spaces 111, respectively.

The pack venting hole 113 may be formed in the pack housing 110 to oppose the venting passage 112. In an example embodiment of the present disclosure, the pack venting hole 113 may be provided in the form of a through-hole formed in the pack housing 110, and the pack venting hole 113 may be connected to the accommodation space 111 and the venting passage 112.

In an example embodiment of the present disclosure, a blocking unit 140 closing the pack venting hole 113 may be provided in the pack housing 110. In an example embodiment of the present disclosure, the blocking unit 140 may be provided between the accommodation space 111 and the venting passage 112. The blocking unit 140 may be fixed to the pack housing 110 to close at least one pack venting holes 113.

In an example embodiment of the present disclosure, six blocking units 140 may close six pack venting holes 113, respectively.

In an example embodiment of the present disclosure, the blocking unit 140 may be inserted into the pack venting hole 113 to block and close the pack venting hole 113, or may be provided to have a width wider than a width of the pack venting hole 113 and may be attached to the inside of the pack housing 110, such that the blocking unit 140 may be provided in the form of a shield covering the pack venting hole 113 from the outside of the pack venting hole 113.

The blocking unit 140 may face a side surface of the pack unit (130 in FIG. 2). The blocking unit 140 may block substances generated in the pack unit (130 in FIG. 2) from entering the pack venting hole 113 while allowing venting gas to flow into the pack venting hole 113. The above-described substances may include a spark, flame, dust generated from the pack unit (130 in FIG. 2), and a substance separated from the pack unit (130 in FIG. 2) or the pack housing 110.

The blocking unit 140 may receive a predetermined level of pressure by the venting gas and the substances. While the pressure received from the venting gas and the substances is lower than a reference pressure, the blocking unit 140 may block the substances from entering the pack venting hole 113 while allowing the venting gas to flow into the pack venting hole 113.

The venting gas, generated in the pack unit (130 in FIG. 2), passing through the blocking unit 140, and flowing into the pack venting hole 113, may pass through the venting passage 112 to be discharged to the outside of the pack housing 110.

Accordingly, the propagation of a substance generated in one pack unit (130 in FIG. 2) to another pack unit (130 in FIG. 2) may be prevented or minimized while allowing the venting gas to be normally discharged. In addition, the inflow of the substance into the venting passage 112 may be prevented or minimized, thereby preventing the occurrence of an additional fire caused by the substance encountering high-temperature venting gas in the venting passage 112.

In addition, a flame or spark may be blocked from being discharged to the venting passage 112, and to prevent or minimize thermal runaway and thermal propagation of the battery pack, thereby improving safety in use of the battery pack.

In addition, the propagation of a flame and ignition between accommodation spaces 111 isolated from each other may be prevented and minimized due to the partition wall member 120.

In addition, the blocking unit 140 may serve to prevent or minimize the propagation or movement of a substance in the accommodation space 111 divided into six spaces. Therefore, the propagation of a fire or thermal runaway occurring in one accommodation space 111 to another accommodation space 111 may be prevented and minimized.

FIG. 2 is an exploded perspective view of the battery pack 100 according to an example embodiment of the present disclosure.

As illustrated in FIG. 2, a plurality of pack units 130 may be accommodated in the accommodation spaces 111 isolated from each other by the partition wall member 120, respectively.

The pack unit 130 may include a plurality of battery cells 131, and the plurality of battery cells 131 may be accommodated in the accommodation frame 132.

The accommodation frame 132 may include a plurality of busbar members 133, and an anode tab 131a and a cathode tab 131b of the battery cell 131 may be welded to the busbar members 133, respectively.

In an example embodiment of the present disclosure, a pad member 135 may be provided between the plurality of battery cells 131. The pad member 135 may serve to provide surface pressure to the battery cell 131. In addition, in an example embodiment, when the pad member 135 is formed of a material having high thermal conductivity, the cooling effect of the battery cell 131 may be improved. In another example embodiment, the pad member 135 may include a mica material, thereby preventing thermal propagation.

A plurality of cell venting holes 134 may be provided in opposite side surfaces of the accommodation frame 132. The cell venting hole 134 may be provided in the form of a hole passing through the accommodation frame 132. The cell venting hole 134 may face the blocking unit 140, and may serve as a passage through which venting gas generated in the battery cell 131 and the above-described substance are discharged to the outside of the accommodation frame 132.

The number and area of the cell venting holes 134 may be appropriately selected and applied according to the number of battery cells 131 accommodated in the accommodation frame 132.

Upper and/or lower portions (+Z and −Z directions) of the plurality of battery cells 131 accommodated in the accommodation frame 132 may be exposed to the accommodation space 111. When a lower direction is exposed, the lower portions of the plurality of battery cells 131 may face the pack housing 110, thereby increasing sizes (heights) of the battery cells 131 and increasing battery capacitance. In addition, when a cooling passage (not illustrated) is formed in the pack housing 110, a thermal conduction member may be selectively disposed between the pack housing 110 and the plurality of battery cells 131, thereby increasing cooling efficiency.

In an example embodiment of the present disclosure, a length of the blocking unit 140 in a Y-axis direction may be equal to or greater than a length of the pack venting hole 113 in the Y-axis direction, and a length of the blocking unit 140 in a Z-axis direction may be equal to or greater than a height of the pack venting hole 113 in the Z-axis direction.

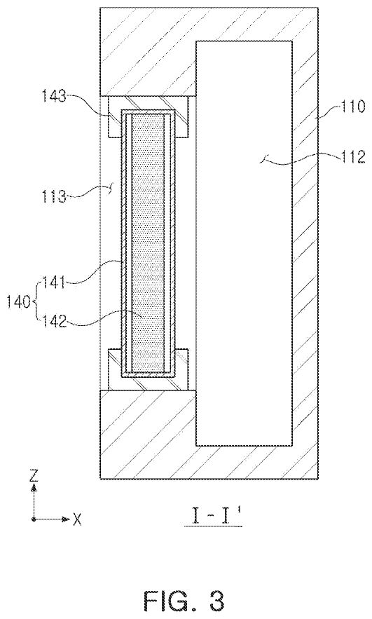

FIG. 3 illustrates line I-I′ of FIG. 2.

As illustrated in FIG. 3, in an example embodiment of the present disclosure, the blocking unit 140 may be disposed in the pack venting hole 113, and may include a first blocking member 141 facing the venting passage 112 and a second blocking member 142 accommodated in the first blocking member 141.

The first blocking member 141 may face a cell venting hole (134 in FIG. 2) of a pack unit (130 in FIG. 2) in an −X direction, and may face the venting passage 112 in an +X direction.

In an example embodiment, the first blocking member 141 may be supported by a support member 143, and the support member 143 may be fixed to the pack housing 110 by a bolt (not illustrated), a screw (not illustrated), welding, and the like.

In an example embodiment, the first blocking member 141 may be provided in the form of a sheet, and may be formed of a material including an insulating material. In addition, in an example embodiment, the first blocking member 141 may be formed of an inorganic material. The first blocking member 141 may be fixed to the support member 143 by a bolt (not illustrated) a screw (not illustrated), a tape (not illustrated), an adhesive (not illustrated), and the like, or may be fixed to the support member 143 in the form of being coupled to the support member 143 in a fitting manner.

In an example embodiment of the present disclosure, a reference pressure may have a value within a range from 1.5 bars to 2.5 bars. The reference pressure may be set within a range capable of protecting a plurality of pack units (130 in FIG. 2) respectively accommodated in a plurality of accommodation spaces 111 isolated from each other by a partition wall member (120 in FIG. 1).

The first blocking member 141 may be provided not to be broken at a pressure lower than the reference pressure, but may be provided to be broken at a pressure higher than or equal to the reference pressure. The first blocking member 141 may serve to prevent a substance and a flame from propagating to another adjacent pack unit (130 in FIG. 2) while enduring a pressure lower than the reference pressure.

In another example embodiment of the present disclosure, the value of the reference pressure may be 2 bars. When the value of the reference pressure is 2 bars, the first blocking member 141 may be provided not to be broken at a pressure of less than 2 bars, but may be provided to be broken at a pressure of 2 bars or more. The first blocking member 141 may serve to block a material other than venting gas from flowing into the venting passage 112. A material of the first blocking member 141 may be appropriately selected such that the first blocking member 141 is not broken at a pressure lower than the reference pressure.

The first blocking member 141 may block a substance from being discharged to the outside of the pack venting hole 113 while receiving pressure of less than 2 bars. The first blocking member 141 may prevent or minimize the movement or propagation of a substance to another pack unit (130 in FIG. 2) while receiving pressure of less than 2 bars.

The first blocking member 141 may be provided to be broken at a pressure of 2 bars or more. In this case, the first blocking member 141 may be entirely broken or may be partially broken. When the first blocking member 141 is broken, a substance generated in the pack unit (130 in FIG. 2) may pass through the first blocking member 141 to face the second blocking member 142.

The second blocking member 142 may be accommodated in the first blocking member 141, and may have a mesh structure. The mesh structure of the second blocking member 142 may serve to block a substance other than venting gas from flowing into the venting passage 112 while facilitating the inflow of the venting gas into the venting passage 112.

A substance included in the venting gas may be filtered by the mesh structure of the second blocking member 142 and may remain in the pack venting hole 113 or an accommodation space (111 in FIG. 2). Accordingly, according to the present disclosure, it is possible to prevent a substance that may cause fire from entering the venting passage 112.

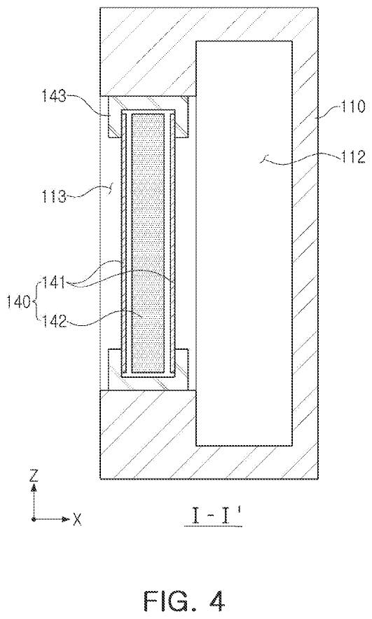

FIG. 4 illustrates line I-I′ of FIG. 2 according to another example embodiment of the present disclosure.

As illustrated in FIG. 4, in another example embodiment of the present disclosure, a pair of first blocking members 141 may be provided. The second blocking member 142 may be disposed between the pair of first blocking members 141.

When the pair of first blocking members 141 are provided, the first blocking members 141 may be formed of different materials, and may be formed to have standards. In an example embodiment, when a material of an inner first blocking member 141 disposed in an −X direction with respect to the second blocking member 142 and facing the pack unit (120 in FIG. 2) is formed to have rigidity higher than that of an outer first blocking member 141 facing the venting passage 112, and the inner first blocking member 141 is formed to be thicker than the outer first blocking member 141, the first blocking member 141 may have further improved durability.

In addition, the outer first blocking member 141 may be formed to be relatively thin, thereby contributing to a reduction in weight of a battery pack (100 in FIG. 1) and a reduction in manufacturing costs.

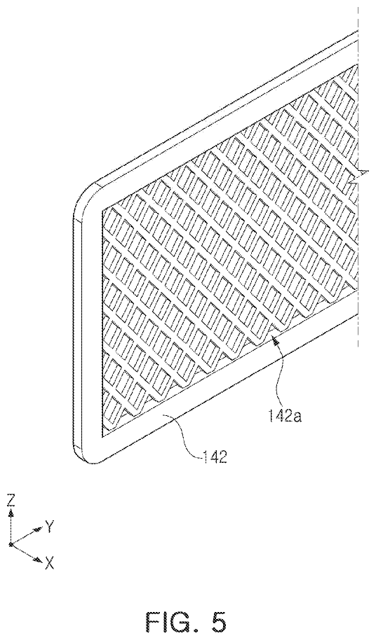

FIG. 5 is a partial perspective view of the second blocking member 142 according to an example embodiment of the present disclosure.

As illustrated in FIG. 5, the second blocking member 142 may include a mesh region 142a having a mesh structure. The mesh region 142a may be formed to have 24 or more eyes per area of 1 in², thereby easily preventing a substance other than venting gas from flowing into a venting passage (112 in FIG. 4).

When the mesh region 142a has less than 24 eyes per area of 1 in², the area of the eyes may become relatively wider, such that a substance generated from the pack unit (130 in FIG. 2) may easily pass through the mesh region 142a. In particular, the substance generated in the pack unit (130 in FIG. 2) may pass through the mesh region 142a to block the venting passage (112 in FIG. 2). When the venting passage (112 in FIG. 2) is clogged or narrowed by the substance, the venting gas may not be smoothly discharged.

In addition, a substance having a large particle may enter the venting passage (112 in FIG. 2), may float along the venting passage (112 in FIG. 2), and then may be attached to another pack unit (130 in FIG. 2). When the particle adheres to a busbar member (133 in FIG. 2) of the pack unit (130 in FIG. 2), a short circuit may occur, which may lead to a secondary explosion.

When the mesh region 142a has 24 or more eyes per area of 1 in², the eyes may be formed relatively densely. Then, it may be relatively difficult for the substance generated in the pack unit (130 in FIG. 2) to pass through the mesh region 142a, and only the venting gas may pass through the mesh region 142a.

In addition, in an example embodiment of the present disclosure, a plurality of second blocking members 142 may be provided, and the plurality of second blocking members 142 may be mutually stacked in an X-axis direction to form a structure of a sandwich panel. The second blocking member 142 may be formed of a material including at least one of steel and copper.

Accordingly, the substance generated in the pack unit (130 in FIG. 2) may be easily filtered out, and the substance generated in the pack unit (130 in FIG. 2) may be easily blocked from being discharged to the venting passage (112 in FIG. 2).

The above-described blocking unit (140 in FIG. 2) may also be provided at an inlet and an outlet of the venting passage (112 in FIG. 2), thereby preventing or minimizing the propagation of fire to a vehicle (not illustrated) in which a battery pack (100 in FIG. 2) is mounted.

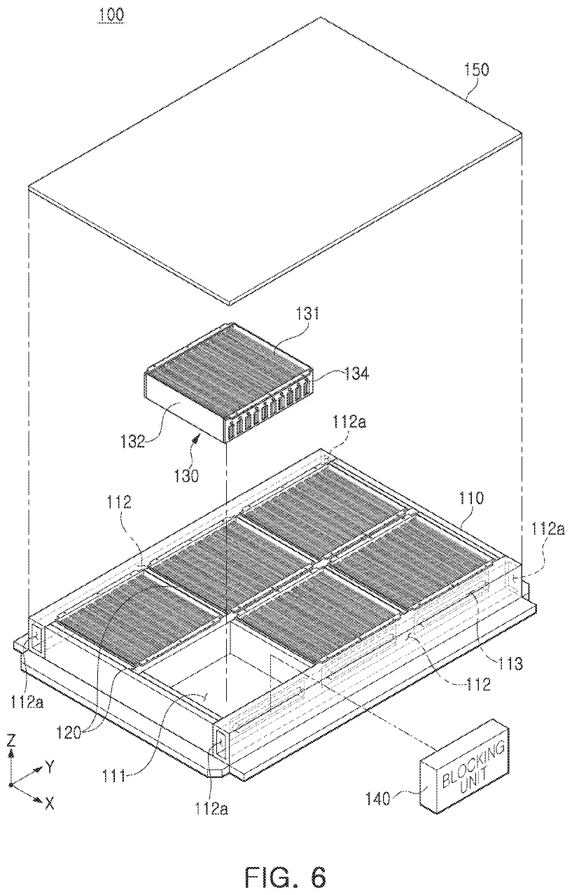

FIG. 6 is an exploded perspective view of the battery pack 100 according to another example embodiment of the present disclosure.

As illustrated in FIG. 6, a battery pack according to another example embodiment of the present disclosure may further include a pack cover 150 covering the accommodation space 111 or the pack unit 130.

The pack cover 150 may be disposed on upper portions of the pack unit 130 and the pack housing 110 in a +Z direction, and may be coupled to the pack housing 110 by a bolt (not illustrated), a screw (not illustrated), or the like.

The pack cover 150 may block a spark, a flame, and the like from being discharged to the upper portion of the pack housing 110. A material of the pack cover 150 is not necessarily limited by the present disclosure, and may be appropriately selected and applied according to specifications of the battery pack.

A cooling unit (not illustrated) may be connected to the pack housing 110 and the pack cover 150 to cool the battery pack.

While example embodiments have been shown and described above, it will be apparent to those skilled in the art that modifications and variations could be made without departing from the scope of the present disclosure as defined by the appended claims.

What is claimed is:

1. A battery pack comprising:
a pack housing including an accommodation space and a venting passage connecting the accommodation space to outside;
a partition wall member partitioning the accommodation space;
a plurality of pack units including battery cells, the plurality of pack units disposed in the accommodation space; and
a blocking unit provided between the accommodation space and the venting passage, the blocking unit blocking a substance generated in the pack unit from entering the venting passage.

2. The battery pack of claim 1, wherein the blocking unit includes:
a first blocking member facing the pack unit and the venting passage, the first blocking member blocking the substance from entering the venting passage while receiving pressure lower than a reference pressure; and
a second blocking member disposed within the first blocking member, the second blocking member having a mesh structure.

3. The battery pack of claim 2, wherein
the first blocking member is provided to be broken at a pressure higher than or equal to the reference pressure,
the second blocking member is provided to block the substance from entering the venting passage at a pressure higher than or equal to the reference pressure.

4. The battery pack of claim 2, wherein the pack unit includes:
an accommodation frame accommodating at least one of the battery cells;
a busbar member provided in the accommodation frame, the busbar member electrically connected to an electrode tab of the battery cell; and
at least one cell venting hole provided in the accommodation frame.

5. The battery pack of claim 4, wherein
the pack housing has a pack venting hole facing the cell venting hole, the pack venting hole connected to the venting passage, and
the first blocking member and the second blocking member are disposed in the pack venting hole.

6. The battery pack of claim 5, wherein
the blocking unit includes a plurality of first blocking members facing the cell venting hole and the venting passage, and
the second blocking member is disposed between the plurality of first blocking members.

7. The battery pack of claim 6, wherein the plurality of first blocking members are formed of a material including an insulating material.

8. The battery pack of claim 2, wherein the second blocking member has a mesh structure having 24 or more eyes per area of 1 in².

9. The battery pack of claim 2, wherein the reference pressure has a value within a range from 1.5 bars to 2.5 bars.

10. The battery pack of claim 1, further comprising:
a pack cover covering the pack unit.
